(19) United States
(12) Patent Application Publication
(10) Pub. No.: US 2010/0090927 A1
(43) Pub. Date: Apr. 15, 2010

(54) Ladder Display System

(75) Inventors: Jeremy R. Hochman, Austin, TX (US); Jeffrey T. Maddox, Austin, TX (US)

Correspondence Address: AKA CHAN LLP, 900 LAFAYETTE STREET, SUITE 710, SANTA CLARA, CA, 95050, US

(73) Assignee: ELEMENT LABS, INC., Santa Clara, CA (US)

(21) Appl. No.: 12/529,688

(22) PCT Filed: Mar. 7, 2008
(86) PCT No.: PCT/US08/03060

§ 371 Date: Sep. 2, 2009

Related U.S. Application Data
(60) Provisional application No. 60/893,758, filed on Mar. 8, 2007.

(51) Int. Cl. G09G 5/00; H01J 9/00

(52) U.S. Cl. 345/1.3; 445/24

(57) ABSTRACT

A system and a method for creating a light emitting apparatus are disclosed herein. The light emitting apparatus includes at least one display module having at least one light emitting element, in which the display module is connected between one of a support and a support bar at one end and another of a support and a support bar at the other end. The display module may then be electrically connected to another display module and be configured to emit light using the light emitting element.

### CROSS-REFERENCE TO RELATED APPLICATIONS

This application, pursuant to 35 U.S.C. §119(e), claims priority to U.S. patent application Ser. No. 60/893,758 filed on Mar. 8, 2007 and entitled “Ladder Display System” in the name of Jeremy Hochman and Jeff Maddox, which is hereby incorporated by reference in its entirety.

### BACKGROUND

1. Field of the Disclosure

Embodiments disclosed herein generally relate to light emitting apparatuses.

More specifically, embodiments disclosed herein relate to an improved method and apparatus for emitting light, in which the light emitting apparatus may be used within many different environments.

2. Background Art

Display units for entertainment, architectural, and advertising purposes have commonly been constructed from numbers of light emitting elements, such as light emitting diodes (“LEDs”) or incandescent lamps mounted onto flat panels. The light emitting elements may be selectively turned on and off to create patterns, graphics, and video displays for both informational and aesthetic purposes. It is well known to construct these displays as tiles or large panels which are assembled in position for a specific entertainment show or event, or also as an architectural or advertising display. Examples of such systems are disclosed in U.S. Pat. Nos. 6,813,853, 6,704,989 and 6,314,669.

As the LED video market expands into new domains, the classic fixed structure of the LED video panel may become a limitation. Designers, architects, and advertisers may desire the flexibility and versatility to use only one or a few products within the rapidly changing environment of the modern era. For example, a panel or modular box system may work well in a stadium score board or as an advertisement on the Las Vegas Strip, but the large panels may have limitations on transparency and weight.

Accordingly, there may be a requirement at an event or within a theatrical production to use a display system that is easily removable, for example, moving the display system in between scenes of a play and as the needs of the production dictates. A display apparatus constructed as a large panel or as a series of solid tiles bolted or permanently fixed together may be very inappropriate for such an application or need. The displays may be large and heavy, and require abundant support machinery, time, and storage space for installation. For example, as disclosed in U.S. Pat. No. 6,704,989, issued to Lutz, an electronic signal display system requires the individual display sections be lifted out of storage cases with a lifting truss and then joined and stacked appropriately for display.

To improve upon these limitations, as described above, many existing products are being developed with a degree of transparency and to weigh less than their panel based counterparts. An example of such a prior art display apparatus is disclosed in U.S. Pat. No. 6,237,290 (“Tokimoto”).

Tokimoto discloses a system that effectively integrates the electronic and structural components for use in a building. In this case, the LED ribs are incorporated into a void in the glass wall of the building. However, there may be limitations to the method disclosed in Tokimoto. For example, maintaining the system within the void is complicated. The system disclosed by Tokimoto could be used to back light a graphic on the glass exterior; however, issues with line of sight would prevent the system from acting as a part of the graphic. This may be the result in the alignment of the system and the graphic shifting as the viewer moves. Further, the system may not function as a finished surface and may be difficult to access and maintain.

Another requirement for display systems used for events, such as theatrical productions, is for the display to be easily and quickly configurable to multiple sizes and shapes, thereby allowing the system to suit different installations and logistical constraints. However, while these LED tile systems usually focus on transparency and light weight, the systems generally require frames and ground support structures. For example, the light tile systems often use an extruded aluminum housing that must be attached to a metal frame of some sort. These frames may then be ground supported by an external structure to make use of rigging systems when creating LED tile systems of significant size. As such, these systems generally create an additional cost and tend to work against the goal of creating a transparent and light weight wall system. Accordingly, there exists a need for a light emitting apparatus that improves upon these prior art support structures for continued development and success within the various light emitting industries.

### SUMMARY OF THE DISCLOSURE

In one aspect, embodiments disclosed herein relate to a light emitting apparatus. The light emitting apparatus includes a first display module and a second display module, each comprising at least one light emitting element, a first support and a second support, and a first spacer and a second spacer. A first end of the first display module and a first end of the second display module are connected to the first support and the first spacer is disposed between the first end of the first display module and the first end of the second display module. A second end of the first display module and a second end of the second display module are connected to the second support and the second spacer is disposed between the second end of the first display module and the second end of the second display module.

In another aspect, embodiments disclosed herein relate a light emitting apparatus including a first display module and a second display module, each comprising at least one light emitting element, and a first support bar, a second support bar, a third support bar, and a fourth support bar. A first end of the first display module is connected to the first support bar and a second end of the first display module is connected to the second support bar. A first end of the second display module is connected to the third support bar and a second end of the second display module is connected to the fourth support bar. The first support bar and the third support bar are connected together, and the second support bar and the fourth support bar are connected together.

In yet another aspect, embodiments disclosed herein relate to a light emitting apparatus including a display module. The display module includes a first light emitting element, a second light emitting element, a structural member, in which the structural member connects the first light emitting element to the second light emitting element. The apparatus then further includes one of a first support and a first support bar and one of a second support and a second support bar. A first end of the display module is connected to the one of the first support and the first support bar. A second end of the display module is connected to the one of the second support and the second support bar.

Further, in yet another aspect, embodiments disclosed herein relate to a method of constructing a light emitting apparatus. The method includes providing a first display module and a second display module, in which the first display module and the second display module each comprise at least one light emitting element, and connecting a first end of the first display module to a first support and a second end of the first display module to a second support. The method then further includes disposing a first spacer about the first support and a second spacer about the second support, and connecting a first end of the second display module to the first support and a second end of the second display module to the second support. The first spacer is disposed between the first end of the first display module and the first end of the second display module. The second spacer is disposed between the second end of the first display module and the second end of the second display module.

Furthermore, in yet another aspect, embodiments disclosed herein relate a light emitting apparatus including a first display module having a first light emitting element and a second light emitting element, in which a first structural member connects the first light emitting element to the second light emitting element, and a second display module having a third light emitting element and a fourth light emitting element, wherein a second structural member connects the third light emitting element to the fourth light emitting element. A first wiring system electrically connects the first light emitting element to the third light emitting element. A second wiring system electrically connects the second light emitting element to the fourth light emitting element.

Other aspects and advantages of the present disclosure will be apparent from the following description and the appended claims.

### BRIEF DESCRIPTION OF DRAWINGS

FIG. 1 shows a perspective view of a light emitting apparatus having a display module in accordance with embodiments disclosed herein.

FIG. 2 shows a perspective view of a light emitting apparatus having multiple display modules in accordance with embodiments disclosed herein.

FIG. 3 shows a perspective view of a light emitting apparatus having multiple display modules in accordance with embodiments disclosed herein.

FIG. 4 shows a perspective view of a light emitting apparatus having multiple display modules in accordance with embodiments disclosed herein.

FIG. 5 shows a perspective view of a light emitting apparatus having multiple display modules in accordance with embodiments disclosed herein.

FIG. 6 shows a perspective view of a light emitting apparatus having multiple display modules in accordance with embodiments disclosed herein.

FIG. 7A shows a perspective view of a light emitting apparatus having multiple display modules in accordance with embodiments disclosed herein.

FIG. 7B shows another perspective view of the light emitting apparatus shown in FIG. 7A in accordance with embodiments disclosed herein.

### DETAILED DESCRIPTION

Specific embodiments of the present disclosure will now be described in detail with reference to the accompanying figures. Like elements in the various figures may be denoted by like reference numerals for consistency. Further, in the following detailed description of embodiments of the present disclosure, numerous specific details are set forth in order to provide a more thorough understanding of the invention. However, it will be apparent to one of ordinary skill in the art that the embodiments disclosed herein may be practiced without these specific details. In other instances, well-known features have not been described in detail to avoid unnecessarily complicating the description.

In one aspect, embodiments disclosed herein generally relate to a light emitting apparatus having one or more display modules. A display module may include one or more light emitting elements, in which the light emitting elements may then be connected by structural members disposed therebetween. Further, the module of the apparatus may then be connected at each end to a support or a support bar. If the module is connected to supports, then spacers may be placed adjacent to the ends of the module to maintain a desired distance between the module and another module. If the module is connected to support bars, then when the module connects to another module, the support bars of this module may connect with support bars connected to the other module. Further, when forming or assembling the light emitting apparatus, the modules of the light emitting apparatus may electrically connect. For example, the light emitting elements of the modules may electrically connect to each other.

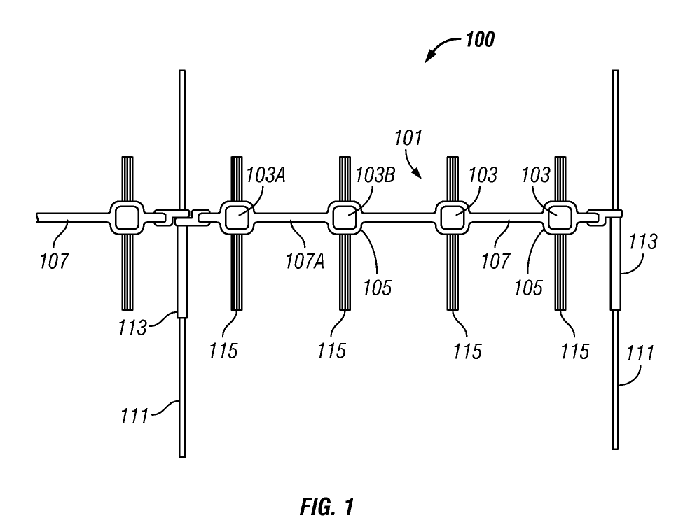

Referring now to FIG. 1, a perspective view of a light emitting apparatus 100 in accordance with embodiments disclosed herein is shown. The light emitting apparatus 100 includes a display module 101, in which the display module 101 includes one or more light emitting elements 103. Specifically, the display module 101 may include a housing 105, in which the light emitting elements 103 may be disposed within the housing 105. Further, assuming the display module 101 includes one or more light emitting elements 103, a structural member 107 may be disposed between the light emitting elements 103. As shown, the structural member 107 may be integrally formed as part of the housing 105. However, the present disclosure is not so limited, as in another embodiment, assuming no housing is present, then a structural member may still be disposed between the light emitting elements.

The structural member 107 may be used to connect the light emitting elements 103 to each other then. For example, the structural member 107A may be disposed between and connect the light emitting element 103A and the light emitting element 103B. As such, the structural member 107A may be formed from a rigid material, such as a plastic or metal, and provide structural rigidity between the light emitting elements 103A and 103B.

Further, the light emitting apparatus 100 may include supports 111, spacers 113, and one or more wiring systems 115. In this embodiment, one end of the display module 101 is connected to one of the supports 111, and the other end of the display module 101 is connected to the other of the supports 111. As such, the display module 101 is connected to and disposed between each of the supports 111. Furthermore, the spacers 113 may be used to retain the ends of the module 101 in position on the supports 111 (described more below). Furthermore still, a wiring system 115 may be electrically connected to one or more of the light emitting elements 103. As such, the wiring system 115 may electrically connect the display module 101 to another display module. For example, light emitting elements 103 of the display module 101 may be electrically connected to other light emitting elements of an adjacent display module (described more below).

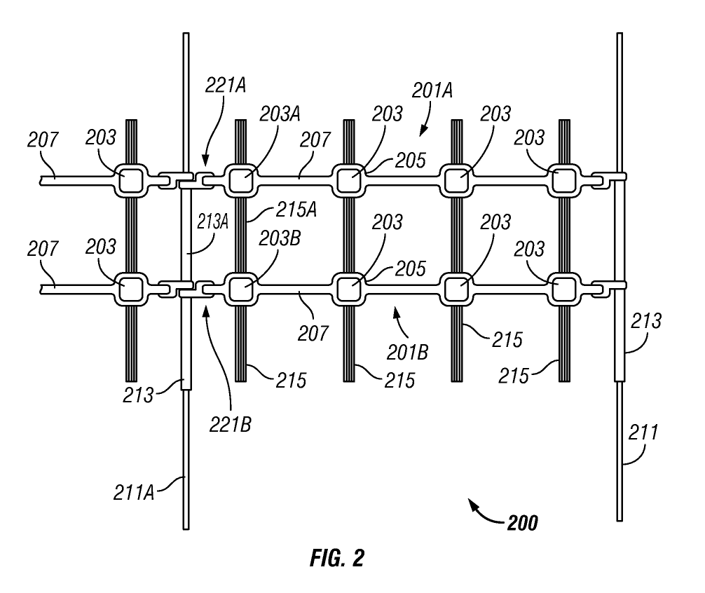

Referring now to FIG. 2, a perspective view of a light emitting apparatus 200 having multiple display modules 201 in accordance with embodiments disclosed herein is shown. Specifically, in this embodiment, the light emitting apparatus 200 includes two display modules 201. As described above, the display modules 201 may each include one or more light emitting elements 203, in addition to each possibly including a housing 205. Further, the display modules 201 may include one or more structural members 207. As such, assuming the display modules 201 include more than one light emitting element 203, then the structural member 207 may be disposed between the light emitting elements 203 so as to connect the light emitting elements 203 to each other.

As shown, the light emitting apparatus 200 includes supports 211 and spacers 213. As such, one end of the display modules 201 may be connected to one of the supports 211, and another end of the display modules 201 may be connected to another of the supports 211, thereby having the display modules 201 connected to and disposed between the supports. When one of the ends of the display modules 201 connects with the support 211, the end of the display module 201 may slidably and rotatably connect with the support 211. As such, the end of the display module 201 may then slide along and rotate about the support 211. However, the present disclosure is not so limited, in which other embodiments of the present disclosure may have one or more ends of the display modules non-slidably and/or non-rotatably connect with the supports.

Further, the spacers 213 may be disposed adjacent to the ends of the display modules 201. As shown, when the ends of the display modules 201 are connected to the supports 211, the spacers may be disposed between the ends of each of the display modules 201. For example, end 221A and 221B of the display modules 201A and 201B, respectively, are each connected to the support 211A, in which the spacer 213A is disposed between each of the ends 221A and 221B. The spacer 213A may then be connected to the support 211A, such as by disposing the spacer 213A about the support 211A. As such, similar to the ends 221A and 221B of the display modules 201A and 201B, respectively, the spacer 213A may slidably and rotatably connect with the support 211A. Thus, the spacer may then slide along and rotate about the support 211A. However, the present disclosure is not so limited, in which other embodiments of the present disclosure may have one or more spacers non-slidably and/or non-rotatably connect with the supports.

The spacers 213 may then be formed or manufactured in different sizes, such as in different lengths, so as to control the distance between each of display modules 201 as desired. As such, by including the spacers 213 within the light emitting apparatus 200, the display modules 201 may have a desired separation and distance formed therebetween. For example, in the embodiment shown in FIG. 2, the spacers 213 are formed such that the distance between each of the display modules 201 is approximately the same distance between the light emitting elements 203 of each of the display modules 201. However, those having ordinary skill in the art will appreciate that the present disclosure is not so limited, in which the spacers may be formed having any desired length.

Furthermore, as described above, the display modules 201 may electrically connect to each other. For example, as shown in FIG. 2, the display module 201A electrically connects to display module 201B. Specifically, a light emitting element 203A of the display module 201A includes a wiring system 215A electrically connected thereto, in which the wiring system 215A then electrically connects to a light emitting element 203B of the display module 201B.

By having the wiring system 215A disposed between and electrically connecting the light emitting elements 203A and 203B, data and/or power signals may be transmitted between the light emitting elements 203A and 203B. As such, the light emitting apparatus 200 may then be electrically connected to a power unit and/or a main processor. The power unit and the main processor may send power signals and/or data signals back and forth with the light emitting apparatus 200, in particular with the light emitting elements 203 of the light emitting apparatus 200. Based on the power signal, the light emitting elements may be selectively powered on and off or emit light with varying intensities, and based on the data signal, the light emitting elements may selectively emit light of different colors. Furthermore, with multiple light emitting elements and display modules connected to each other, the lighting emitting apparatus in accordance with embodiments disclosed herein may be configured to display an image based upon the power and data signals.

Furthermore still, the supports 211 may be formed from a rigid or a flexible material. Preferably though, the support is formed from a flexible material, such as, but not limited to, a cable, a wire, a rope, a cord, or a mesh material. Regardless though, even assuming the supports 211 are formed from a rigid or a flexible material, the supports may provide mechanical support for the light emitting apparatus 200 and may provide accurate positioning for the display modules 201.

Preferably, multiple portions of the light emitting apparatus are formed from a transparent material so as to increase the transparency of the light emitting apparatus. As such, the supports and/or the spacers of the light emitting apparatus may be formed from a transparent material. For example, each of the supports and the spacers may be formed from a transparent plastic resin. Further, the display modules may be substantially formed from a transparent material. For example, the structural members and/or the housing may be formed from a rigid transparent material. This use of transparent materials may increase the ability of a viewer to see-through the light emitting display. However, those having ordinary skill in the art will appreciate that embodiments of the present disclosure are not so limited, in which the light emitting apparatus may instead be formed with multiple portions having an opaque material.

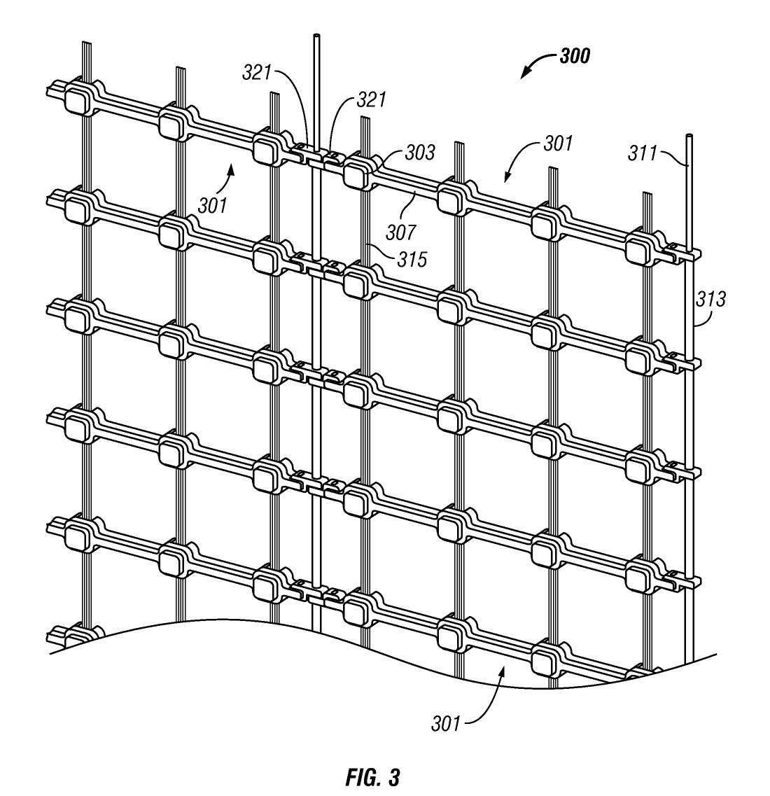

Referring now to FIG. 3, a perspective view of a light emitting apparatus 300 in accordance with embodiments disclosed herein is shown. In this embodiment, the light emitting apparatus 300 includes multiple display modules 301 connected to supports 311, in which spacers 313 are disposed between ends 321 of the display modules 301. As discussed above, the display modules 301 include light emitting elements 303, in which structural members 307 may be disposed between and connect the light emitting elements 303. Further, the display modules 301 of the light emitting apparatus 300 may be electrically connected to each other. Specifically, by using wiring systems 315, the light emitting elements 303 from one display module 301 may electrically connect with the light emitting elements 303 of another display module 301.

Further, as also described above, the display modules 301 of the light emitting apparatus 300 may be formed with a rigid material, such as by forming the structural members 307 from a rigid plastic material, and the supports 311 may be formed with a flexible material, such as with a chord. In such an embodiment, the light emitting apparatus 300 may be configured to be rigid in one direction and flexible in another direction. For example, in this embodiment, the light emitting apparatus 300 will be rigid in a direction parallel to the display modules 301. As such, the rigidity of the light emitting apparatus 300 will prevent, until failure of the rigid material, folding of the light emitting apparatus 300 in a direction parallel to the display modules 301. On the other hand, in this embodiment, the light emitting apparatus 300 will be flexible in a direction perpendicular to the display modules 301. Therefore, this flexibility will allow folding or rolling of the light emitting apparatus 300 in a direction perpendicular to the display modules 301. However, by including the spacers 313, the light emitting apparatus 300 may only be folded with a minimum size radius. By properly designing the spacers 313 of the light emitting apparatus 300 then, this minimum size radius of the fold with the spacers 313 may prevent any damage from folding or rolling the light emitting apparatus 300 too tightly.

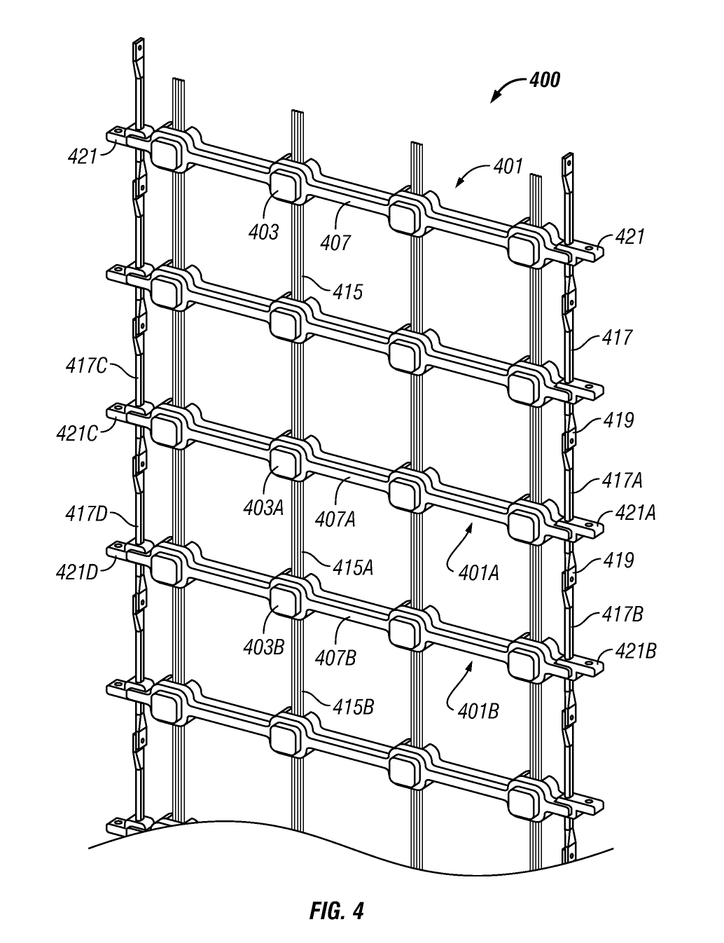

Referring now to FIG. 4, a perspective view of a light emitting apparatus 400 having multiple display modules 401 in accordance with embodiments disclosed herein is shown. In this embodiment, as similar to above, the display modules 401 include one or more light emitting elements 403, in which the light emitting elements 401 of each display modules 401 may be connected to each other by a structural member 403. Further, the display modules 401 may be electrically connected to each other, such as by having the light emitting elements 401 of one display module 401 electrically connected to other light emitting elements 401 of another display module 401 by a wiring system 415.

However, in this embodiment, rather than including supports and/or spacers, the light emitting apparatus includes support bars 417. These support bars 417 may be used to provide support, in addition to proper spacing, for the display modules 401 and the light emitting apparatus 400. As such, an end 421 of one or more of the display modules 401 may be connected to one of the support bars 417, and another end 421 of one or more of the display modules may be connected to another of the supports bars 417. A support bar 417 would then be connected to each end 421 of the one or more display modules 421. Similar to the display modules connecting to the supports of above, when one of the ends 421 of the display modules 401 connects with the support bar 417, the end 421 may slidably and rotatably connect with the support bar 417. The end 421 of the display module 401 may then slide along and rotate about the support bar 417. However, the present disclosure is not so limited, in which other embodiments of the present disclosure may have one or more ends of the display modules non-slidably and/or non-rotatably connected with the support bars.

Referring still to FIG. 4, a display module 401A has one end 421A connected to a support bar 417A and has another end 421C connected to a support bar 417C. Further, a display module 401B has one end 421B connected to a support bar 417B and has another end 421D connected to a support bar 417D. As such, when assembling the light emitting apparatus 400, the support bars 417A and 417B may be connected to each other, and the support bars 417C and 417D may be connected to each other. As shown, in this embodiment, the ends 419 of the support bars 417 are connected to each other. Then, when the support bars 417 are connected to each other, the support bars may rotatably connect with each other. As such, the support bars 417 may then rotate with respect to each other. However, the present disclosure is not so limited, in which other embodiments of the present disclosure may have one or more ends of the support bars non-slidably connected with each other.

The support bars 417 may then be formed or manufactured in different sizes, such as in different lengths, so as to control the distance between each of the display modules 401 as desired. As such, by including the support bars 417 within the light emitting apparatus 400, the display modules 401 may have a desired and separation and distance formed therebetween, as similar to the light emitting apparatuses of above with the spacers.

Preferably, the support bars are formed from a transparent material so as to increase the transparency of the light emitting apparatus. For example, the support bars may be formed from a transparent plastic resin, or from a rigid transparent material. This use of the transparent material may increase the ability of a view to see-through the light emitting display. However, those having ordinary skill in the art will appreciate that embodiments of the present disclosure are not so limited, in which the support bars may instead be formed from an opaque material.

Further, preferably the support bars are formed from a rigid material so as to provide support for the light emitting apparatus. For example, the support bars may be formed from a rigid plastic, or from a metal. This use of a rigid material may increase rigidity of the light emitting apparatus and the ability of the light emitting apparatus to carry higher loads. However, those having ordinary skill in the art will appreciate that embodiments of the present disclosure are not so limited, in which the support bars may instead be formed from an non-rigid material.

Regardless, assuming the support bars 417 are formed from a rigid or a non-rigid material, the light emitting apparatus 400 may still be configured to be rigid in one direction and flexible (e.g. foldable) in another direction. For example, in FIG. 4, the light emitting apparatus 400 will be rigid in a direction parallel to the display modules 401. As such, the rigidity of the light emitting apparatus 400 will prevent, until failure of the rigid material, folding of the light emitting apparatus 400 in a direction parallel to the display modules 401. On the other hand, in this embodiment, the light emitting apparatus 400 will be flexible in a direction perpendicular to the display modules 401. Therefore, this flexibility will allow folding or rolling of the light emitting apparatus 400 in a direction perpendicular to the display modules 401. However, by including the support bars 417, particularly if the support bars 417 are formed from a rigid material, the light emitting apparatus 400 may only be folded with a minimum size radius. By properly designing the support bars 417 of the light emitting apparatus 400 then, this minimum size radius of the fold with the support bars 417 may prevent any damage from folding or rolling the light emitting apparatus 400 too tightly.

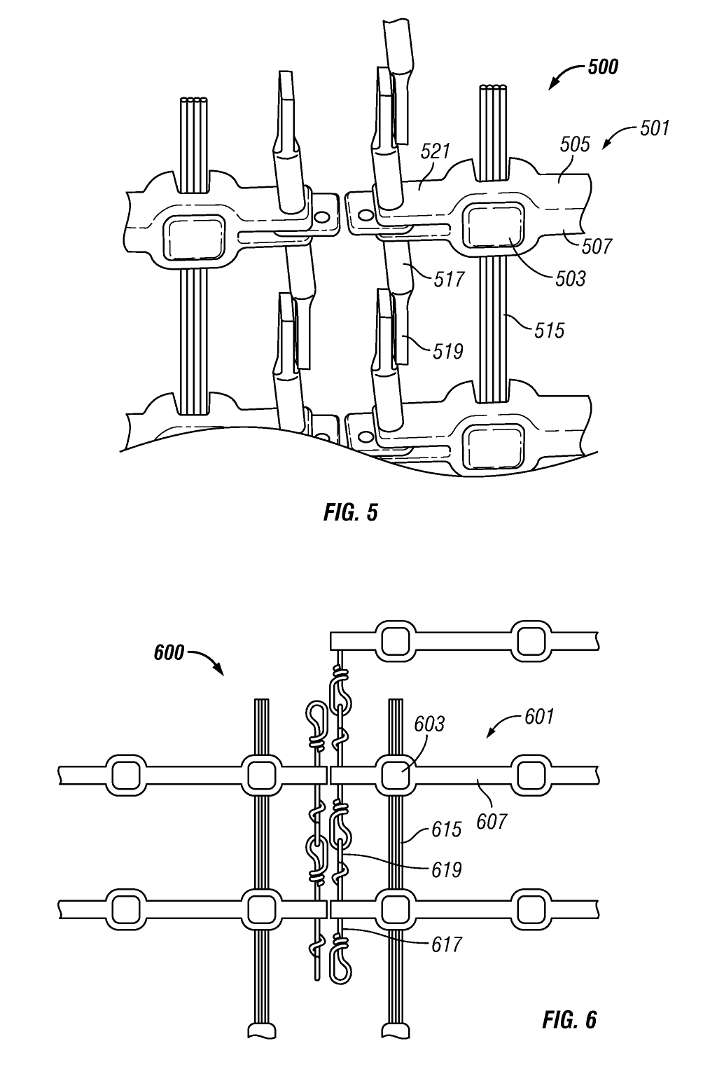

Referring now to FIG. 5, a perspective view of a light emitting apparatus 500 is shown. As similar to the above embodiment in FIG. 4, the light emitting apparatus 500 includes multiple display modules 501, in which the display modules 501 include one or more light emitting elements 503. Further, the display modules 501 are electrically connected to each other, and ends 521 of the display modules 501 are connected to support bars 517. However, in this embodiment, rather than having the ends 521 of the display modules 501 rotatably connected to the support bars 517, as shown in FIG. 4, the ends 521 of the display modules 501 are non-rotatably connected to the support bars 517. Rather, in this embodiment, the support bars 517 are integrally formed with the display modules 501. For example, the support bars 517 may be integrally formed with a housing 505 of the display modules 501. The support bars 517 may then still connect at ends 519 to other support bars 517, in which the support bars 517 may rotatably connect with each other.

Referring now to FIG. 6, a perspective view of a light emitting apparatus 600 is shown. As similar to the above embodiment in FIGS. 4 and 5, the light emitting apparatus 600 includes multiple display modules 601, in which the display modules 601 include one or more light emitting elements 603. Further, the display modules 601 are electrically connected to each other, and ends 621 of the display modules 601 are connected to support bars 617. In this embodiment, then, the ends 621 of the display modules 601 are rotatably connected to the support bars 617. The support bars 617 are rotatably connected at ends 619 to each other. As such, the support bars 617 are each offset by about 90° of rotation from each other.

Further, as shown, the support bars 617 may be formed from a wire. In the embodiment in FIG. 6, the support bars 617 are particularly formed from a rigid wire. However, as shown in FIG. 5, the support bars may also be formed from a rigid plastic material, or as shown in FIG. 4, the support bars may be formed with a larger cross-section. Regardless, as described above, the support bars may be formed with any shape or size, or from any particular type material, so as the support bars provide support and spacing for the light emitting apparatus.

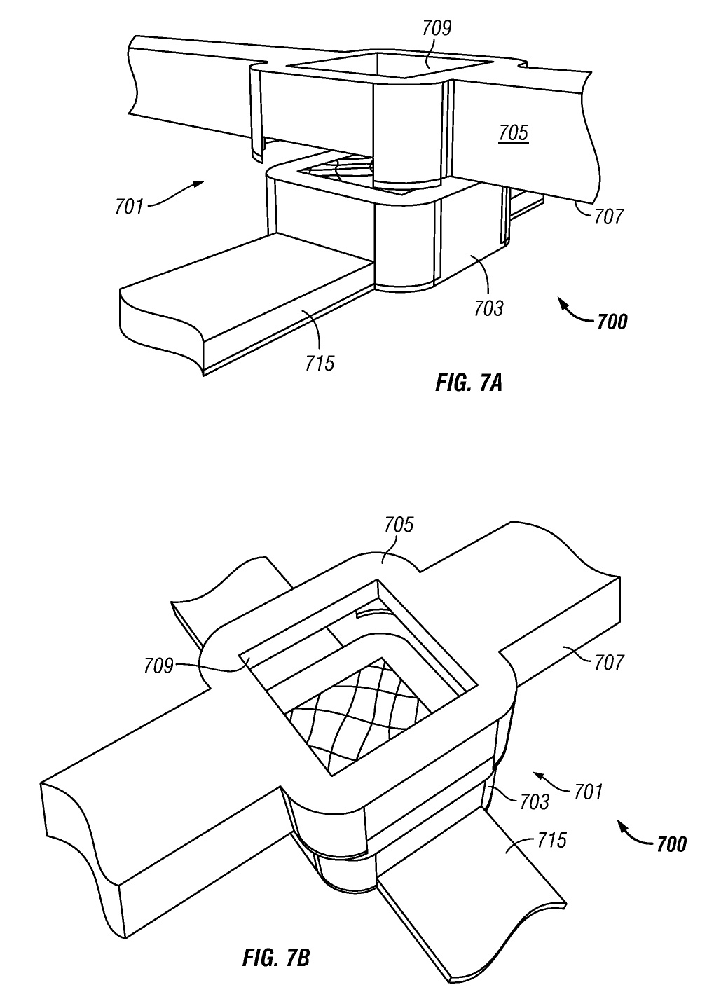

Referring now to FIGS. 7A and 7B, multiple views of a light emitting apparatus 700 in accordance with embodiments disclosed herein is shown. The light emitting apparatus 700 includes a display module 701, in which the display module 701 includes a housing 705 and a light emitting element 703. The housing 705, as shown, includes a cavity 709 formed therein, in which the light emitting element 703 may be received within the cavity 709. For example, the light emitting element 703 may be received and retained within the cavity 709 by having an interference fit engagement between the light emitting element 703 and the cavity 709 of the housing 705. However. the present disclosure is not so limited, and other methods and structures may be used to receive the light emitting element within the cavity.

Further, as shown, the display module 701 includes a wiring system 715, in which the wiring system 715 is electrically connected to the light emitting element 703. This enables the display module 701, and particularly the light emitting element 703, to electrically connect with other display modules 701. Furthermore, the display module 701 includes a structural member 707, in which, in this embodiment, the structural member 707 is integrally formed with the housing 705. As such, the structural member 707 enables the light emitting element 703 to connect to other light emitting elements 703 of the display module 701.

As discussed, the light emitting apparatus of the present disclosure includes one or more light emitting elements. Generally, the light emitting apparatus will include multiple light emitting elements. Each of these light emitting elements may then include one or more light emitters. For example, in one embodiment, a light emitting element may only include one light emitter. However, in another embodiment, a light emitting element may include multiple light emitters, such as having three light emitters. The light emitters may then be a light emitting diode, an organic light emitting diode, a polymer light emitting diode, or any other light emitting element know in the art. Assuming more than one light emitter is used within a light emitting element, the light emitters may then be the same or different colors, or the same or different sizes, or the same or different types.

Further, as shown and described herein, the light emitting elements of the light emitting apparatuses are arranged in a regular array. However, those having ordinary skill in the art will appreciate that in other embodiments, the present disclosure is not so limited, as the light emitting elements may instead be arranged in a random, or in a pseudo-random arrangement. When having a random or pseudo-random arrangement, the supports, the spacers, the support bars, the structural members, and other various components of the light emitting apparatus may have varied shapes and sizes.

Furthermore, as also shown and described herein, the light emitting elements of the light emitting apparatus are arranged to only emit light in one direction. However, those having ordinary skill in the art will appreciate that in other embodiments, the present disclosure is not so limited, as the light emitting elements may instead be arranged to emit light in more than one direction. For example, in another embodiment, the light emitting elements may be arranged such that light emitters are configured to emit light in two directions, such as from two opposite sides of the light emitting element. As such, this would increase the visibility of the light emitted by the light emitting apparatus.

Embodiments disclosed herein may provide for one or more of the following advantages. First, the present disclosure may provide for a lightweight light emitting apparatus. This lightweight light emitting apparatus may increase the versatility to expand the different uses for the apparatus. Next, the present disclosure may provide for a light emitting apparatus that is transparent. This transparency may prevent having the apparatus impede any visuals for a lighting arrangement. Further, the present disclosure may provide for a light emitting apparatus that may be quickly and easily connected and disconnected. For example, the quick assembly of the display modules of the light emitting apparatus may reduce the setup time of the light emitting apparatus. Finally, the present disclosure may provide for a light emitting apparatus that is adaptable to fit multiple types of environments and various lighting needs. The light emitting apparatus may be customized, such as each light module may be customized, to form a light emitting apparatus having different sizes, shapes, and arrangements.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

1. A light emitting apparatus comprising:
a first display module and a second display module, each comprising light emitting elements;
a first support and a second support; and
a first spacer and a second spacer, wherein a first end of the first display module and a first end of the second display module are connected to the first support and the first spacer is disposed between the first end of the first display module and the first end of the second display module,
a second end of the first display module and a second end of the second display module are connected to the second support and the second spacer is disposed between the second end of the first display module and the second end of the second display module,
the first spacer has a first spacer first end and a first spacer second end, both coupled to the first support,
the light emitting elements of the first display module extend in a first direction from the first end to the second end of the first display module,
the light emitting elements of the second display module extend in the first direction from the first end to the second end of the second display module, and
the first support and first spacer extend in a second direction, transverse to the first direction,
the second support and second spacer extend in the second direction.

2. The apparatus of claim 1 wherein the first display module is electrically connected to the second display module.

3. The apparatus of claim 2 wherein the first display module is electrically connected to the second display module using a wiring system.

4. The apparatus of claim 1 wherein the first display module comprises:
a first light emitting element;
a second light emitting element; and
a first structural member, a wherein the first structural member connects the first light emitting element to the second light emitting element.

5. The apparatus of claim 2 wherein the second display module comprises:
a third light emitting element;
a fourth light emitting element; and
a second structural member, wherein the second structural member connects the third light emitting element to the fourth light emitting element.

6. The apparatus of claim 5 wherein the first light emitting element of the first display module is electrically connected to the third light emitting element of the second display module, and the second light emitting element of the first display module is electrically connected to the fourth light emitting element of the second display module.

7. The apparatus of claim 1 wherein the first end of the first display module and the first end of the second display module are slidably and rotatably connected to the first support, and the second end of the first display module and the second end of the second display module are slidably and rotatably connected to the second support.

8. The apparatus of claim 1 wherein the first spacer is disposed about the first support, and the second spacer is disposed about the second support.

9. The apparatus of claim 8 wherein the first spacer is slidably and rotatably connected to the first support, and the second spacer is slidably and rotatably connected to the second support.

10. The apparatus of claim 1 wherein at least one of the first support and the second support comprise a flexible material.

11. The apparatus of claim 10 wherein the flexible material comprises at least one of a mesh material, a cable, a wire, a rope, or a cord.

12. A light emitting apparatus, comprising:
a first display module and a second display module, each comprising at least one light emitting element; and
a first support bar, a second support bar, a third support bar, and a fourth support bar,
wherein a first end of the first display module is connected to the first support bar and a second end of the first display module is connected to the second support bar,
a first end of the second display module is connected to the third support bar and a second end of the second display module is connected to the fourth support bar,
the first support bar and the third support bar are connected together, and
the second support bar and the fourth support bar are connected together.

13. The apparatus of claim 12 wherein the first support bar and the third support bar are rotatably connected together, and wherein the second support bar and the fourth support bar are rotatably connected together.

14. The apparatus of claim 12 wherein the first support bar, the second support bar, the third support bar, and the fourth support bar comprise a rigid material.

15. The apparatus of claim 12 wherein the first end of the first display module is rotatably connected with the first support bar, the second end of the first display module is rotatably connected with the second support bar, the first end of the second display module is rotatably connected with the third support bar, and the second end of the second display module is rotatably connected with the fourth support bar.

16. The apparatus of claim 12 wherein the first end of the first display module is non-rotatably connected with the first support bar, the second end of the first display module is non-rotatably connected with the second support bar, the first end of the second display module is non-rotatably connected with the third support bar, and the second end of the second display module is non-rotatably connected with the fourth support bar.

17. The apparatus of claim 16 wherein the first end of the first display module is integrally formed with the first support bar, the second end of the first display module is integrally formed with the second support bar, the first end of the second display module is integrally formed with the third support bar, and the second end of the second display module is integrally formed with the fourth support bar.

18. The apparatus of claim 12 wherein the first display module and the second display module are electrically connected together.

19. The apparatus of claim 12 wherein the first display module comprises:
a first light emitting element;
a second light emitting element; and
a first structural member, wherein the first structural member connects the first light emitting element to the second light emitting element; and
the second display module comprises:
a third light emitting element;
a fourth light emitting element; and
a second structural member, wherein the second structural member connects the third light emitting element to the fourth light emitting element.

20. The apparatus of claim 19 wherein the first light emitting element is electrically connected to the third light emitting element, and the second light emitting element is electrically connected to the fourth light emitting element.

21. A light emitting apparatus comprising:
a display module, comprising:
a first light emitting element, connected to a first column of flexible wiring;
a second light emitting element, connected to a second column of flexible wiring, not connected to the first column of flexible wiring; and
a structural member, wherein the structural member connects the first light emitting element to the second light emitting element;
one of a first support and a first support bar; and
one of a second support and a second support bar, wherein a first end of the display module is connected to the one of the first support and the first support bar, and
a second end of the display module is connected to the one of the second support and the second support bar.

22. A method of constructing a light emitting apparatus, the method comprising:
providing a first display module in a first row and a second display module in a second row, wherein the first display module and the second display module each comprise at least one light emitting element;
connecting a first end of the first display module to a first support and a second end of the first display module to a second support, the first and second supports extending in a direction transverse to a direction of the first and second rows;
disposing a first spacer about the first support and a second spacer about the second support; and
connecting a first end of the second display module to the first support and a second end of the second display module to the second support, wherein the first spacer is disposed between the first end of the first display module and the first end of the second display module, and the second spacer is disposed between the second end of the first display module and the second end of the second display module.

23. The method of claim 22 further comprising:
electrically connecting the first display module to the second display module; and
sending a signal to the apparatus, wherein one of the first display module and the second display module is configured to emit light based on the signal.

24. A light emitting apparatus comprising:
a first display module having a first light emitting element and a second light emitting element, wherein a first structural member connects the first light emitting element to the second light emitting element; and
a second display module having a third light emitting element and a fourth light emitting element, wherein a second structural member connects the third light emitting element to the fourth light emitting element, wherein a first wiring system electrically connects the first light emitting element to the third light emitting element, and a second wiring system electrically connects the second light emitting element to the fourth light emitting element.

25. The apparatus of claim 24 wherein the apparatus is rigid in a direction parallel to one of the first display module and the second display module, and the apparatus is flexible in a direction perpendicular to one of the first display module and the second display module.
